(19) United States
(12) Patent Application Publication
(10) Pub. No.: US 2006/0173691 A1
(43) Pub. Date: Aug. 3, 2006

(54) Audio mixing processing apparatus and audio mixing processing method

(76) Inventor: Takanobu Mukaide, Tachikawa-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/329,219

(22) Filed: Jan. 11, 2006

(30) Foreign Application Priority Data
Jan. 14, 2005 (JP) 2005-008177

(51) Int. Cl. G10L 21/00

(52) U.S. Cl. 704/500

(57) ABSTRACT

An audio mixing processing apparatus includes input units configured to receive a plurality of audio data, a mixing unit configured to mix the plurality of inputted audio data based on predetermined mixing factors, respectively, an encoding unit configured to encode the mixed audio data, and an output unit configured to output an encoded form of the mixed audio data to the outside.

### CROSS-REFERENCE TO RELATED APPLICATIONS

This application is based upon and claims the benefit of priority from prior Japanese Patent Application No. 2005-008177, filed Jan. 14, 2005, the entire contents of which are incorporated herein by reference.

### BACKGROUND OF THE INVENTION

1. Field of the Invention

The present invention relates to improvements of an audio mixing processing apparatus and an audio mixing processing method used in an optical disk device or the like.

2. Description of the Related Art

As is well known, a variety of optical disks including a digital versatile disk (DVD) have been marketed as digital recording mediums. It is thus demanded that optical disk devices for reproducing such optical disks are improved in the operational reliability.

As the DVD standards have been advanced including high definition (HD) DVD and Blue-ray disk, one of their next generation formats is compatible with the high-vision TV system. Since such a next generation DVD format is much higher in the recording density than the existing DVD systems and the optical disk devices will be desired to have advanced functions.

For example, an optical disk device compatible with the next generation DVD format is designed for mixing a plurality of audio data received from an optical disk and outputting the mixed audio data to the outside. However, the process of mixing audio data can be performed only after decoding a plurality of digital audio data received from an optical disk. More specifically, the optical disk device can output the mixed audio data in only a decoded form after mixing the audio data received from the optical disk.

This prevents the optical disk device from connecting with an external audio decoder such as an external AV amplifier and decoding and reproducing the audio data by the external audio decoder. As the optical disk device is enabled to receive audio data by only analog connection, its utility will hardly be favorable for any user.

Disclosed in Jpn. Pat. Appln. KOKAI Publication No. 2001-100792 is a decoding apparatus arranged at a lower cost for decoding an audio signal to pick up a two-channel reproducing dedicated signal from the 5-channel audio signal constituting one audio data when the 2-channel reproducing dedicated signal produced by down-mix process and other channel audio signals have been encoded and recorded separately.

Also, an arrangement for recording in a memory card an encoded video data which has been read out from an optical disk, decoded, and then encoded again by another encoding method and an encoded audio data which has been read out from the optical disk, decoded, and then encoded again by the another encoding method is disclosed in Jpn. Pat. Appln. KOKAI Publication No. 2002-135717.

Moreover, another arrangement for decoding a first stream signal produced by multiplexing a first encoded video information train with a first encoded audio information train, producing a second encoded video information train which is lower in the bit rate than the first encoded video information train and a second encoded audio information train which is lower in the bit rate than the first encoded audio information train, and multiplexing the second encoded video and audio information trains is disclosed in Jpn. Pat. Appln. KOKAI Publication No. 2002-175098.

### BRIEF SUMMARY OF THE INVENTION

According to one aspect of the present invention, there is provided an audio mixing processing apparatus comprising: input units configured to receive a plurality of audio data; a mixing unit configured to mix the plurality of audio data received by the input units based on predetermined mixing factors, respectively; an encoding unit configured to encode the mixed audio data produced by the mixing unit; and an output unit configured to output an encoded form of the mixed audio data produced by the encoding unit.

According to another aspect of the present invention, there is provided a method of mixing audio data, comprising: a first step of inputting a plurality of audio data; a second step of mixing the plurality of audio data inputted at the first step based on predetermined mixing factors, respectively; a third step of encoding the mixed audio data produced at the second step; and a fourth step of outputting an encoded form of the mixed audio data produced at the third step to the outside.

### BRIEF DESCRIPTION OF THE SEVERAL VIEWS OF THE DRAWING

FIG. 1 is a block diagram of an optical disk device showing one embodiment of the present invention;

FIG. 2 is a schematic explanatory view of a pickup in the optical disk device of the embodiment;

FIG. 3 is a block diagram of a first exemplary arrangement of the audio mixing processing unit in the optical disk device of the embodiment;

FIG. 4 is a block diagram of a second exemplary arrangement of the audio mixing processing unit in the optical disk device of the embodiment;

FIG. 5 is a block diagram of a third exemplary arrangement of the audio mixing processing unit in the optical disk device of the embodiment;

FIG. 6 is a block diagram of a fourth exemplary arrangement of the audio mixing processing unit in the optical disk device of the embodiment;

FIG. 7 is a flowchart showing a part of the primary operation of the audio mixing processing unit in the optical disk device of the embodiment;

FIG. 8 is a flowchart showing the rest of the primary operation of the audio mixing processing unit in the optical disk device of the embodiment;

FIG. 9 is a block diagram of a fifth exemplary arrangement of the audio mixing processing unit in the optical disk device of the embodiment;

FIG. 10 is a flowchart showing an operation of receiving an EDID data from an audio decoder externally connected with the optical disk device of the embodiment; and

FIG. 11 is a block diagram of a sixth exemplary arrangement of the audio mixing processing unit in the optical disk device of the embodiment.

### DETAILED DESCRIPTION OF THE INVENTION

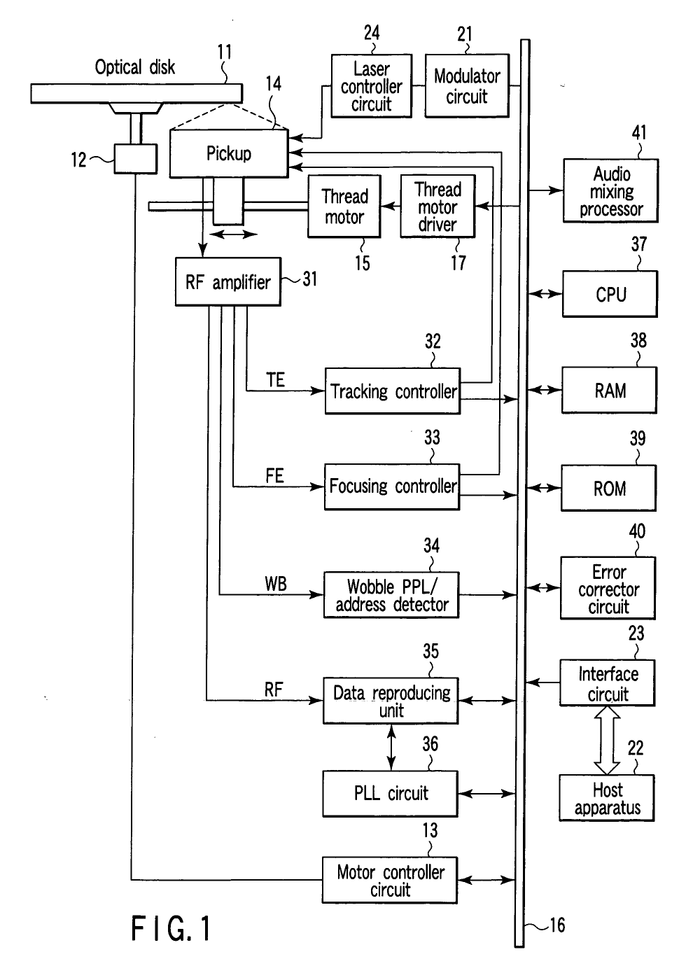

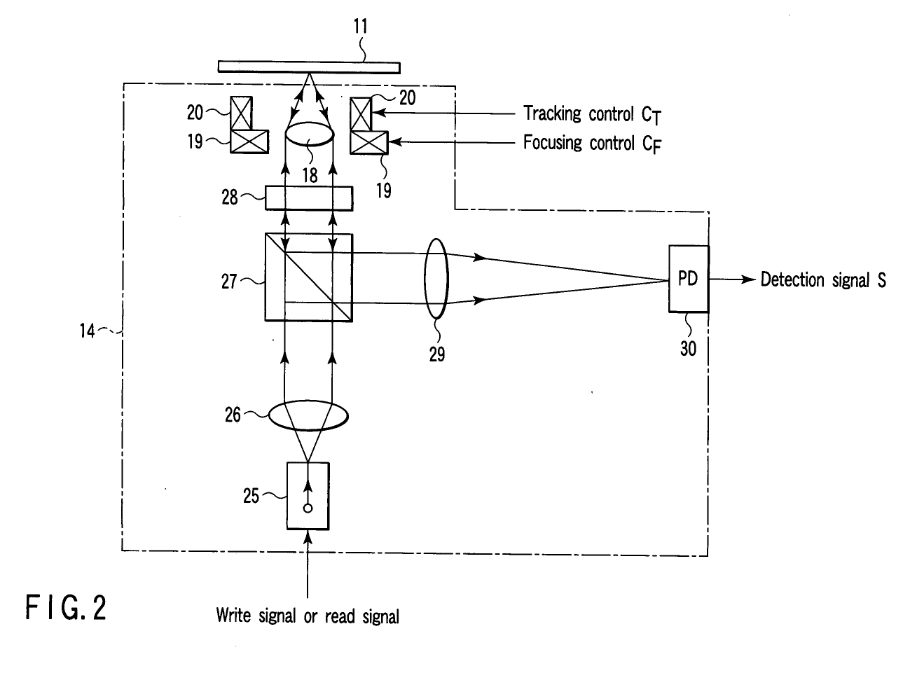

One embodiment of the present invention will be described in more detail referring to the relevant drawings. An optical disk device according to the embodiment has an arrangement shown in FIGS. 1 and 2. An optical disk 11 in the embodiment is a recordable (or rewritable) type next generation DVD while it may be selected from known optical disks of the user data recordable (or rewritable) type and of the read only type.

The recordable or rewritable optical disks 11 include a DVD-RAM (random access memory), a DVD-RW (rewritable), and a DVD-R (recordable) of the next generation type which can be scanned with a blue laser beam at about 405 nm of the wavelength and a DVD-RAM, a DVD-RW, and a DVD-R of the existing type which can be scanned with a red laser beam at about 650 nm of the wavelength.

The optical disk 11 has land tracks and group tracks provided in a spiral form on the surface thereof. The optical disk 11 is driven by the rotating action of a spindle motor 12. The speed of rotation of the spindle motor 12 is controlled by a motor controller circuit 13.

The operation of recording and reproducing data on the optical disk 11 is conducted with a pickup 14. The pickup 14 is linked via a gear mechanism to a thread motor 15. The thread motor 15 is controlled by the operation of a thread motor driver 17 connected with a data bus 16. The stator of the thread motor 15 includes a permanent magnet not shown. When the thread motor 15 is magnetized at its driving coils (not shown), it drives the pickup 14 to move radially of the optical disk 11.

The pickup 14 has an objective lens 18 provided therein as shown in FIG. 2. The objective lens 18 is arranged movable in the focusing direction (along the optical axis of the lens) when driven by the operation of a driving coil 19 and in the tracking direction (along a direction orthogonal to the optical axis) when driven by the operation of another driving coil 20. It allows the operation of track jumping to be conducted by shifting the spot of a laser beam.

A modulator circuit 21 is provided for subjecting a user data received via an interface circuit 23 from a host apparatus 22 to a modulating action, for example, 8-14 modulation (EFM, eight to fourteen modulation) to produce an EFM data at the time of recording information. A laser controller circuit 24 is provided for feeding a semiconductor laser diode 25 with a write signal based on the EFM data received from the modulator circuit 21 at the time of recording information (at the mark generation).

The laser controller circuit 24 also feeds the semiconductor laser diode 25 with a read signal, which is smaller than the write signal, at the time of reading information.

Upon receiving the write signal from the laser controller circuit 24, the semiconductor laser diode 25 emits a laser beam. The laser beam emitted from the semiconductor laser diode 25 passes through a collimator lens 26, a half prism 27, and an optical system 28 and is focused on the optical disk 11 by the objective lens 18. A reflection of the laser beam from the optical disk 11 runs through the objective lens 18, the optical system 28, the half prism 27, and a collector lens 29 and is received by a photo-detector 30.

The photo-detector 30 consists mainly of tetrameric photosensitive cells which in turn feed an RF (radio frequency) amplifier 31 with four detection signals A, B, C, and D respectively. The RF amplifier 31 may employ a push-pull technique to feed a tracking controller 32 with a tracking error signal TE determined by (A+D)−(B+C) and an astigmatism technique to feed a focusing controller 33 with a focusing error signal FE determined by (A+C)−(B+D).

The RF amplifier 31 also feeds a wobble PLL/address detector 34 with a wobble signal WB determined by (A+D)−(B+C) and a data reproducing unit 35 with an RF signal determined by (A+D)+(B+C).

An output signal from the focusing controller 33 is received by the driving coil 19 for driving in the focusing direction. This allows the laser beam to be just focused constantly on the recording layer of the optical disk 11. The tracking controller 32 generates a track driving signal in response to the tracking error signal TE and transfers it to the driving coil 20 for driving in the tracking direction.

Through the focusing control action and the tracking control action, the RF signal which is a sum of signal outputs of the photosensitive cells in the photo-detector 30 is indicative of changes in the reflection of the laser beam resulted from data pits or the like produced along the track on the optical disk 11 corresponding to the recorded information. This signal is supplied to a data reproducing unit 35.

Upon receiving a reproducing clock signal from a PLL circuit 36, the data reproducing unit 35 starts an operation of reproducing the recorded data. The data reproducing unit 35 also has a function of measuring the amplitude of the RF signal which is then received by a central processing unit (CPU) 37.

When the tracking controller 32 controls the movement of the objective lens 18, the thread motor 15 is controlled such that the objective lens 18 is on an optimum position against the optical disk 11. Thus, the pickup 14 is controlled.

The motor controller circuit 13, the laser controller circuit 24, the focusing controller 33, the tracking controller 32, the data reproducing unit 35, and the PLL circuit 36 may be assembled together in a single LSI (large scale integration) chip which acts as a servo controller circuit.

The operation of these circuits is controlled by the CPU 37 over the bus 16. The CPU 37 totally controls the operation of the optical disk device based on various commands received via the interface circuit 23 from the host apparatus 22 or other operation information received from an operating unit, which will be described later.

Also, the CPU 37 utilizes a RAM 38 as a working area while conducting actions determined by the program saved in a ROM (read only memory) 39.

A reproduced signal produced by the data reproducing unit 35 is subjected to the error correcting process of an error corrector circuit 40 and then its video, sub video, and audio components are separately reproduced.

A plurality of digital audio data after the error correcting process are mixed by an audio mixing processor 41 before outputted from the optical disk device.

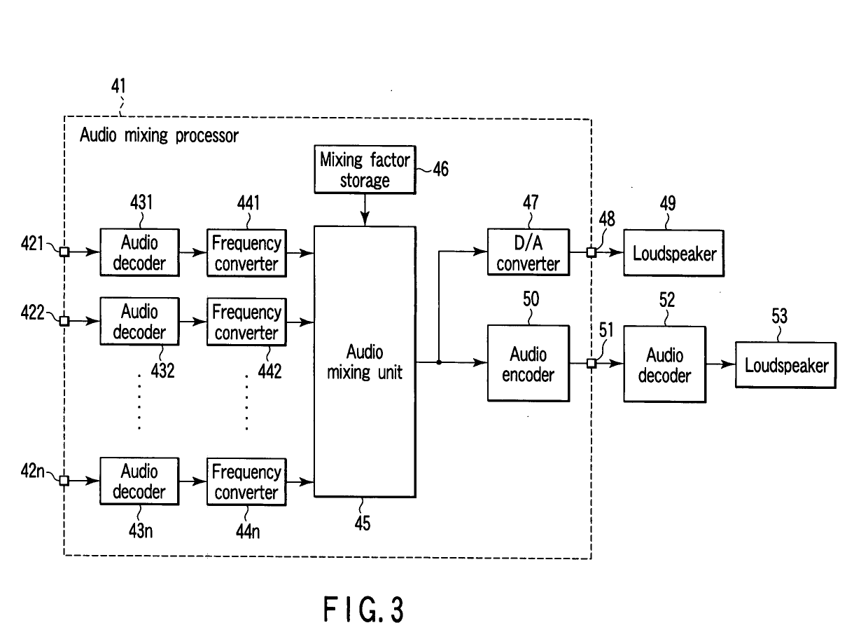

FIG. 3 illustrates a first exemplary arrangement of the audio mixing processor 41, where the digital audio data after the error correcting process are received by audio input ports 421, 422, . . . , 42n respectively.

Then, the audio data received by the audio input ports 421, 422, . . . , 42n are transferred to audio decoders 431, 432, . . . , 43n respectively for decoding process.

The audio data are then transferred from the audio decoders 431, 432, . . . , 43n to frequency converters 441, 442, . . . , 44n respectively where they are processed by a sampling frequency converting process to be equal in the sampling frequency.

The audio data outputted the frequency converters 441, 442, . . . , 44n are received by an audio mixing unit 45. The audio mixing unit 45 is provided for mixing the audio data with reference to the mixing factors 1, 2, . . . , n saved in a mixing factor memory 46.

The mixed audio data produced by the audio mixing unit 45 is converted into an analog form by a digital-to-analog (D/A) converter 47 and transferred via an audio output port 48 to external loudspeakers 49 to be reproduced in a audible form.

Also, the mixed audio data produced by the audio mixing unit 45 is transferred to an audio encoding processor 50 where it is encoded again. An encoded form of the mixed audio data produced by the audio encoding processor 50 is transferred from another audio output port 51 to an external audio decoder 52 which is digitally connected for decoding in, for example, the IEC (International Electro-technical Commission) standard 60958, the IEEE (the Institute of Electrical and Electronics Engineers) standard 1394, or the HDMI (High-Definition Multimedia Interface) standard.

The external audio decoder 52 may incorporate an AV amplifier for decoding and D/A converting the encoded audio data before transferring in an analog form to loudspeakers 53 for reproduction.

The audio mixing processor 41 shown in FIG. 3 allows a plurality of audio data decoded by the audio decoders 431, 432, . . . , 43n, to be mixed together by the audio mixing unit 45, and encoded again by the audio encoding processor 50 before outputted to the outside.

Accordingly, the optical disk device is enabled to digitally connect with any audio decoder 52 which can in turn be operated for decoding and reproducing a decoded form of the mixed audio data. This will improve the utility of the optical disk device for each user.

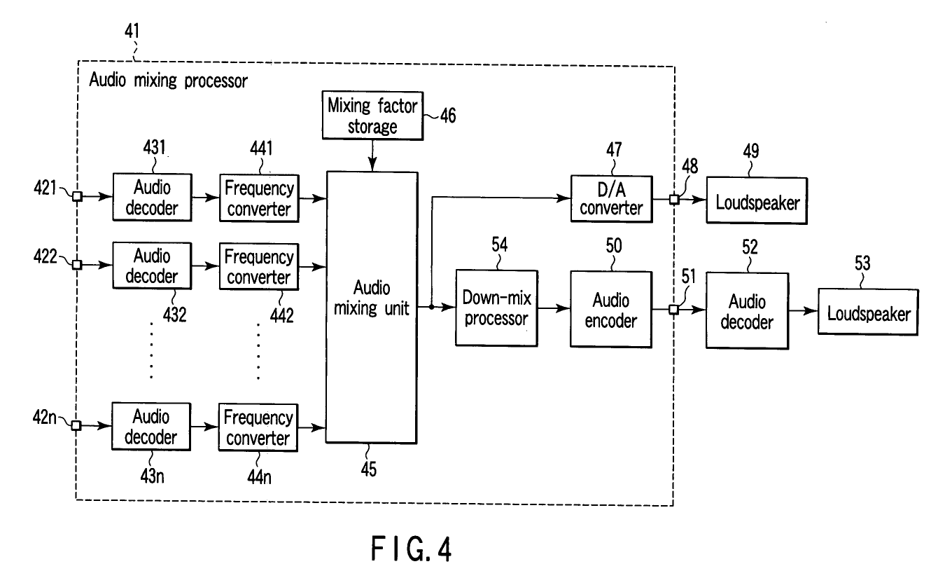

FIG. 4 illustrates a second exemplary arrangement of the audio mixing processor 41. While the same components are denoted by the same numerals as those shown in FIG. 3, audio data are mixed together by the audio mixing unit 45 and transferred to a down-mix processor 54 where its channels are decreased before received by the audio encoding processor 50.

More particularly, the channels in the mixed audio data produced by the audio mixing unit 45 which may be too abundant to be decoded by an external audio decoder 52 is decreased to a desired number by the operation of the down-mix processor 54 before encoded again by the audio encoding processor 50. This will more improve the utility of the optical disk device for a user.

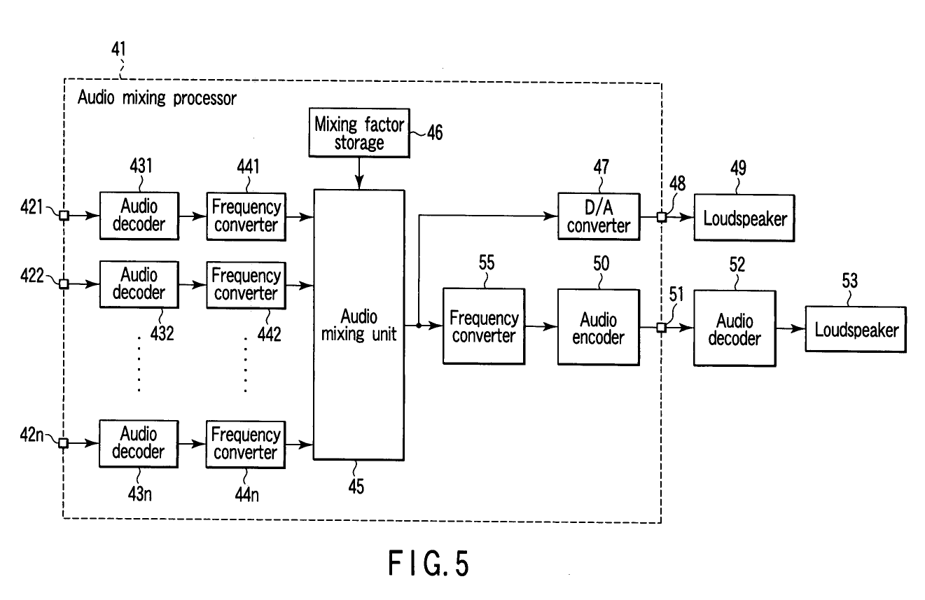

FIG. 5 illustrates a third exemplary arrangement of the audio mixing processor 41. While the same components are denoted by the same numerals as those shown in FIG. 3, audio data are mixed together by the audio mixing unit 45 and transferred to a frequency converter 55 where its sampling frequency is changed before received by the audio encoding processor 50.

More particularly, the sampling frequency in the mixed audio data produced by the audio mixing unit 45 which may be too high to be decoded by an external audio decoder 52 is modified to a desired range by the operation of the frequency converter 55 before encoded again by the audio encoding processor 50. This will more improve the utility of the optical disk device for a user.

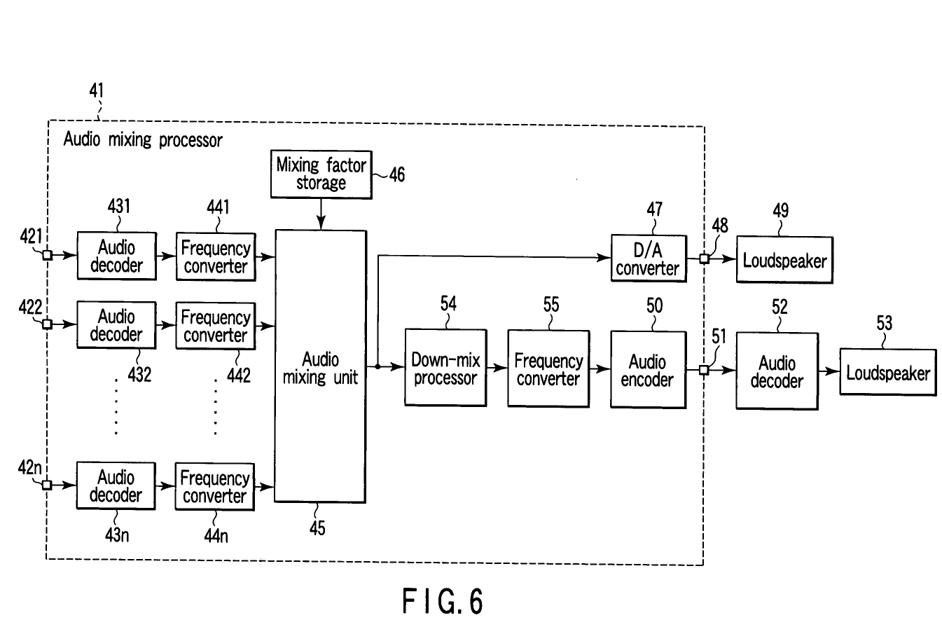

FIG. 6 illustrates a fourth exemplary arrangement of the audio mixing processor 41. While the same components are denoted by the same numerals as those shown in FIG. 3, audio data are mixed together by the audio mixing unit 45 and transferred to the down-mix processor 54 explained in FIG. 4 and the frequency converter 55 explained in FIG. 5 before received by the audio encoding processor 50.

It is now assumed in the arrangement shown in FIG. 6 that the number of channels in the mixed audio data produced by the audio mixing unit 45 is eight and the sampling frequency is 96 kHz while the external audio decoder 52 is designed for decoding the mixed audio data at six channels with its sampling frequency of 48 kHz. Then, the mixed audio data produced by the audio mixing unit 45 is decreased to six channels by the down-mix processing process and modified to 48 kHz of the sampling frequency by the frequency converter 55.

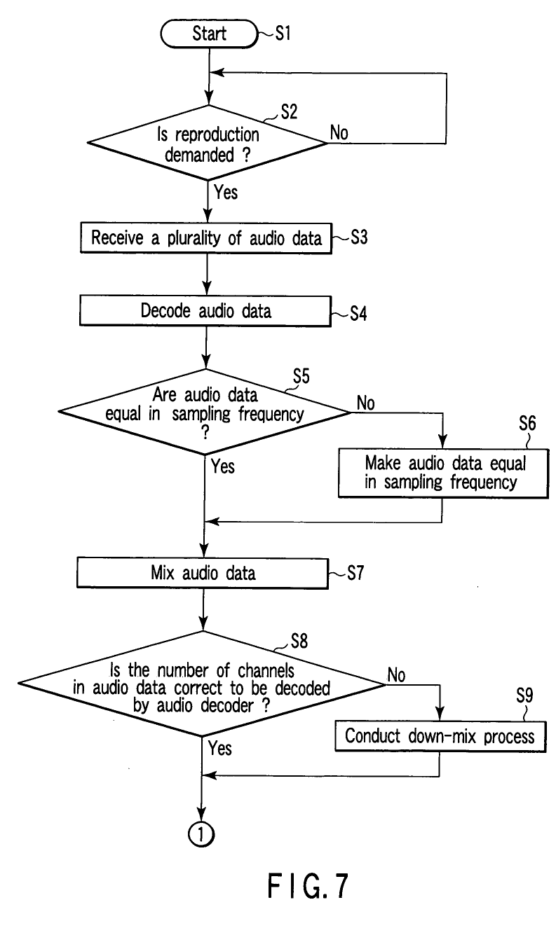

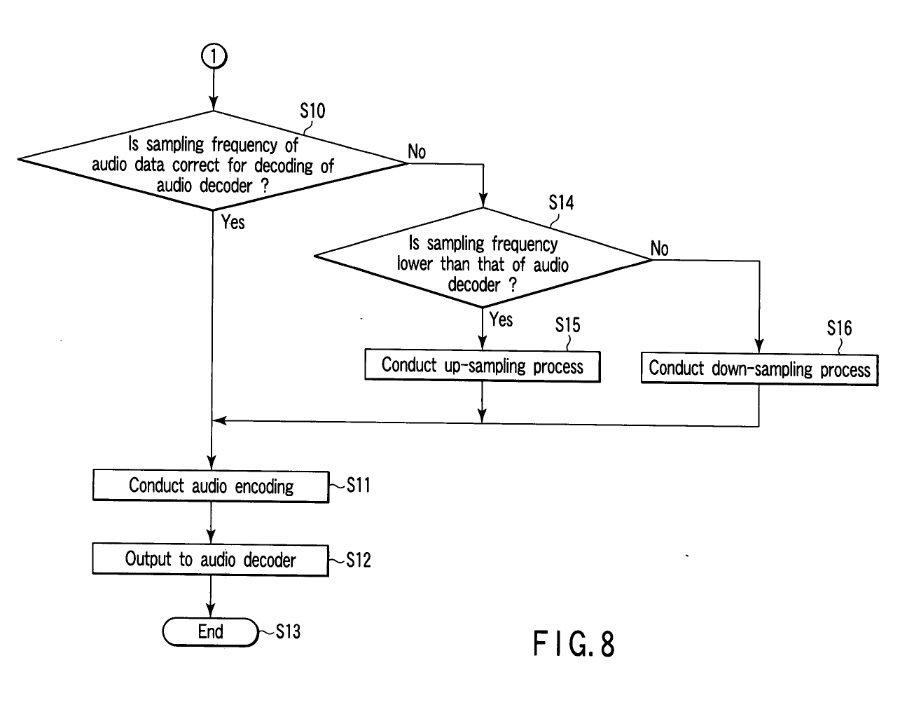

FIGS. 7 and 8 are flowcharts showing a procedure of main process steps in the audio mixing processor 41 shown in FIG. 6. The procedure starts at Step S1 and moves to Step S2 where the CPU 37 in the optical disk device examines whether the reproducing operation of the optical disk device 11 is demanded or not.

When it is judged (yes) that the reproducing action is demanded, the procedure of the CPU 37 goes to Step S3 for retrieving a plurality of audio data from the optical disk 11 and Step S4 for driving the audio decoders 431, 432, . . . , 43n to decode the audio data.

Then, the CPU 37 examines at Step S5 whether or not the sampling frequency is equal between the decoded audio data. When it is judged (no) that the sampling frequency is not equal, Step S6 follows for adjusting the sampling frequency to be equal between the audio data by the frequency converters 441, 442, . . . , 44n.

Directly following Step S6 or when it is judged (yes) at Step S5 that the sampling frequency is equal, the procedure of the CPU 37 moves to Step S7 for mixing the audio data.

The CPU 37 then examines at Step S8 whether or not the number of channels in the mixed audio data is equal to a number assigned to the decoding process of an external audio decoder 52. When it is judged (no) that the number of channel is not an assigned number, the procedure goes to Step S9 where the number of channels in the mixed audio data is decreased to the assigned number by the down-mix processing action of the down-mix processor 54.

Directly following Step S9 or when it is judged (yes) at Step S8 that the number of channels in the mixed audio data is equal to a number assigned to the decoding process of the audio decoder 52, the procedure of the CPU 37 further examines at Step S10 whether or not the sampling frequency of the mixed audio data after the mixing process is equal to a sampling frequency assigned to the decoding process of the audio decoder 52.

When it is judged (yes) that the sampling frequency is equal to a sampling frequency assigned to the decoding process of the audio decoder 52, the procedure of the CPU 37 goes to Step S11 where the mixed audio data after the mixing action is encoded again by the audio encoding processor 50. Then, Step S12 follows where a encoded form of the mixed audio data is transferred to an external audio decoder 52 before the procedure is ended (at Step S13).

When it is judged (no) at Step S10 that the sampling frequency is not equal to a sampling frequency assigned to the decoding action of the audio decoder 52, the CPU 37 examines at Step S14 whether or not the sampling frequency of the mixed audio data is lower than a sampling frequency assigned to the decoding action of the audio decoder 52.

When it is judged (yes) that the sampling frequency is lower, the procedure of the CPU 37 advances to Step S15 where the sampling frequency of the mixed audio data is increased to a higher range or subjected to an up-sampling action of the frequency converter 55 before the procedure goes to Step S11.

When it is judged (no) at Step S14 that the sampling frequency of the mixed audio data is not lower than a sampling frequency assigned to the decoding action of the audio decoder 52, the procedure of the CPU 37 moves to Step S16 where the sampling frequency of the mixed audio data is decreased to a lower range or subjected to a down-sampling action of the frequency converter 55 before the procedure goes to Step S11.

There is a technique for each user to predetermine the number of channels reduced by the down-mix processor 54, the sampling frequency modified by the frequency converter 55, and the audio encoding method in the audio encoding processor 50 so as to match the corresponding settings of an external audio decoder 52 connected with the optical disk device.

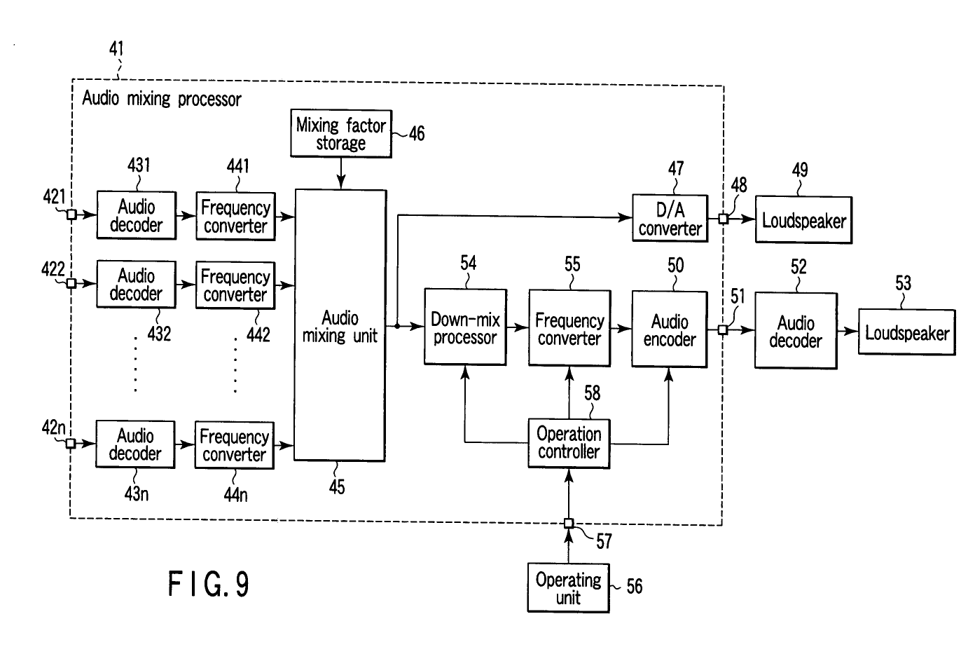

FIG. 9 illustrates a fifth exemplary arrangement of the audio mixing processor 41 where the number of channels, the sampling frequency, and the audio encoding method can be predetermined by the user setting. While the same components are denoted by the same numerals as those shown in FIG. 6, the commands from an operating unit 56 are received via an input port 57 by an operation controller 58.

The operation controller 58 analyzes and reflects the received commands to determine the action of the down-mix processor 54, the frequency converter 55, and the audio encoding processor 50 so that the number of channels, the sampling frequency, and the audio encoding method for the mixed audio data can be adjusted to desired settings.

When the optical disk device is digitally connected to an external audio decoder 52 by the HDMI standard, its CPU 37 extracts an audio attribute data (including the number of channels, the sampling frequency, and the audio encoding method) from the EDID (extended display identification) data assigned to the audio decoder 52 and automatically controls the action of the down-mix processor 54, the frequency converter 55, and the audio encoding processor 50 depending on the audio attribute data.

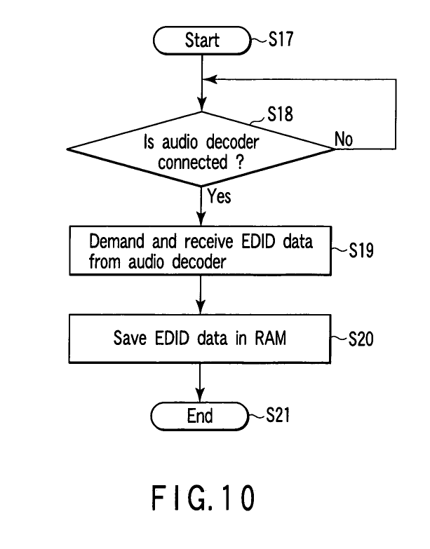

FIG. 10 is a flowchart showing a procedure of the CPU 37 in the optical disk device retrieving the EDID data from the audio decoder 52. The procedure starts at Step S17 and goes to Step S18 where the CPU 37 examines whether an audio decoder 52 is connected or not.

When it is judged (yes) that an audio decoder 52 is connected, the procedure of the CPU 37 goes to Step S19 for retrieving the EDID data from the audio decoder 52 and Step 20 for saving the EDID data in the RAM 38 before ending the process (at Step S21). This allows an audio attribute information assigned to the external audio decoder 52 to be saved in the RAM 38.

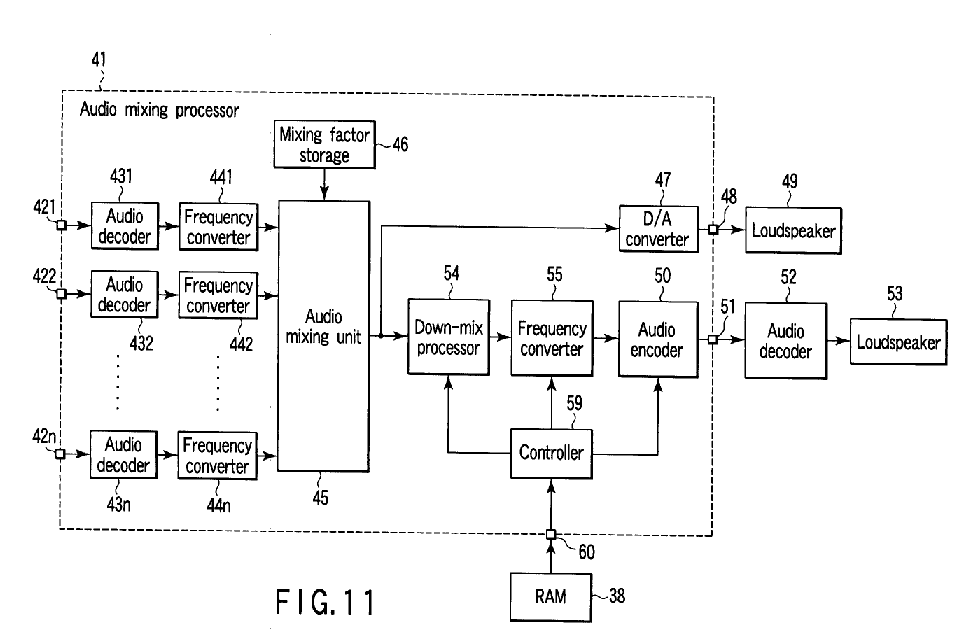

FIG. 11 illustrates a sixth exemplary arrangement of the audio mixing processor 41 where the number of channels, the sampling frequency, and the audio encoding method can automatically be set up using the audio attribute information saved in the RAM 38.

While the same components are denoted by the same numerals as those shown in FIG. 6, a controller 59 is provided in the audio mixing processor 41 and controllably actuated by the CPU 37 for, if needed, receiving an audio attribute information via an input port 60 from the RAM 38 thus to automatically control the operation of the down-mix processor 54, the frequency converter 55, and the audio encoding processor 50.

Although the foregoing embodiment is described in the form of an optical disk device where the audio mixing processor 41 is operated to mix a plurality of audio data read out from the optical disk 11, a plurality of audio data may be received not only from one source, such as the optical disk 11, but from various audio data sources.

For example, the audio mixing processor 41 may receive at its audio input port 421 an audio data from a DVD, at its audio input port 422 an audio data from a server over the network, and at the other input ports numerous audio data extracted from broadcasting signals. As understood, a plurality of audio data received from various audio signal sources can be mixed together with equal success.

When the audio data received by the audio mixing processor 41 need not to be decoded, their decoders 431, 432, . . . , 43n may be eliminated. Similarly, when a plurality of audio data are equal in the sampling frequency, their frequency converters 441, 442, 44n may be eliminated.

While the present invention is not limited to the above described embodiment, various changes and modifications in practice may be made without departing from the scope of the present invention. Also, any combination of the components described in the embodiment will be covered by the spirit of the present invention. For example, some components may be removed from all the components described in the embodiment. Moreover, components in different embodiments may be appropriately combined to constitute another embodiment.

What is claimed is:

1. An audio mixing processing apparatus comprising:
input units configured to receive a plurality of audio data;
a mixing unit configured to mix the plurality of audio data received by the input units based on predetermined mixing factors, respectively;
an encoding unit configured to encode the mixed audio data produced by the mixing unit; and
an output unit configured to output an encoded form of the mixed audio data produced by the encoding unit.

2. An audio mixing processing apparatus according to claim 1, further comprising:
a down-mix unit configured to subject the mixed audio data produced by the mixing unit to a down-mix process for reducing the number of channels in the audio data before transferring the same to the encoding unit.

3. An audio mixing processing apparatus according to claim 2, further comprising:
an operating unit configured to predetermine the number of audio data channels to be reduced by the down-mix unit and an encoding method of the encoding unit for encoding the audio data.

4. An audio mixing processing apparatus according to claim 2, further comprising:
a setting unit configured to predetermine the number of audio data channels to be reduced by the down-mix unit and an encoding method of the encoding unit for encoding the audio data based on audio attribute information received from an external apparatus connected to the output unit.

5. An audio mixing processing apparatus according to claim 1, further comprising:
a frequency converter configured to subject the mixed audio data produced by the mixing unit to a sampling frequency converting process before transferring the same to the encoding unit.

6. An audio mixing processing apparatus according to claim 5, further comprising:
an operating unit configured to predetermine the sampling frequency to be modified by the frequency converter and the encoding method of the encoding unit for encoding the audio data.

7. An audio mixing processing apparatus according to claim 5, further comprising:
a setting unit configured to predetermine the sampling frequency to be modified by the frequency converter and the encoding method of the encoding unit for encoding the audio data based on audio attribute information received from an external apparatus connected to the output port.

8. An audio mixing processing apparatus according to claim 1, wherein
the input units comprise:
input ports configured to receive a plurality of audio data including encoded audio data; and
audio decoders configured to decode the encoded audio data in the audio data received by the input ports before transferring the same to the mixing unit.

9. An audio mixing processing apparatus according to claim 1, wherein
the input units comprise frequency converters configured to make the plurality of audio data equal in the sampling frequency before transferring the same to the mixing unit.

10. A method of mixing audio data, comprising:
a first step of inputting a plurality of audio data;
a second step of mixing the plurality of audio data inputted at the first step based on predetermined mixing factors, respectively;
a third step of encoding the mixed audio data produced at the second step; and
a fourth step of outputting an encoded form of the mixed audio data produced at the third step to the outside.

11. A method of mixing audio data according to claim 10, further comprising:
a fifth step of subjecting the mixed audio data produced at the second step to a down-mix process to reduce the number of channels in the audio data before transferring them to the third step for encoding.

12. A method of mixing audio data according to claim 10, further comprising:
a sixth step of subjecting the mixed audio data produced at the second step to a sampling frequency converting process before transferring them to the third step for encoding.

13. An optical disk device comprising:
a motor configured to drive the rotating movement of an optical disk;
a pickup configured to read a signal from the optical disk driven by the motor for the rotating movement;
a reproducing unit configured to reproduce a plurality of audio data from the signal read by the pickup;
a mixing unit configured to mix the plurality of audio data reproduced by the reproducing unit based on predetermined mixing factors, respectively;
an encoder configured to encode the mixed audio data produced by the mixing unit; and
an output unit configured to output an encoded form of the mixed audio data produced by the encoder to the outside.
